(19) United States
(12) Patent Application Publication
(10) Pub. No.: US 2012/0300959 A1
(43) Pub. Date: Nov. 29, 2012

(54) RIBBON MICROPHONE WITH USB OUTPUT

(76) Inventors: Leonard Marshall, El Segundo, CA (US); Nahusha Bhadravati Mohankumar, Torrance, CA (US); Steven Silva, Santa Monica, CA (US)

(21) Appl. No.: 13/481,191

(22) Filed: May 25, 2012

Related U.S. Application Data
(60) Provisional application No. 61/490,407, filed on May 26, 2011.

(51) Int. Cl. H04R 3/00

(52) U.S. Cl. 381/111

(57) ABSTRACT

A USB ribbon microphone includes a ribbon diaphragm assembly, an amplification circuitry connected to the ribbon diaphragm assembly, an A/D converter connected to the amplification circuitry, and a USB output port connected to the A/D converter for selective connection with a USB input.

### CROSS REFERENCE TO RELATED APPLICATION

This application claims the benefit of U.S. Application Ser. No. 61/490,407, entitled “RIBBON MICROPHONE WITH USB OUTPUT,” filed May 26, 2011

### BACKGROUND OF THE INVENTION

1. Field of the Invention

The invention relates to ribbon microphones employing a USB output.

2. Description of the Related Art

Microphones with ribbon diaphragms are commonly desired for use by musicians and recording engineers because of their ability to capture high-frequency detail. However, currently available ribbon diaphragm microphones, or ribbon microphones, are not adapted for use with USB inputs commonly employed in electronic equipment.

### SUMMARY OF THE INVENTION

It is, therefore, an object of the present invention to provide a USB ribbon microphone including a ribbon diaphragm assembly, an amplification circuitry connected to the ribbon diaphragm assembly, an A/D converter connected to the amplification circuitry, and a USB output port connected to the A/D converter for selective connection with a USB input.

It is also an object of the present invention to provide a USB ribbon microphone wherein the ribbon diaphragm assembly is composed of a thin ribbon diaphragm placed between the poles of a magnet to generate small AC voltages by electromagnetic induction.

It is another object of the present invention to provide a USB ribbon microphone wherein the amplification circuitry produces a signal noise level of 85-92 dB.

It is a further object of the present invention to provide a USB ribbon microphone including a transformer between the ribbon diaphragm assembly and the amplification circuitry to minimize noise while increasing signal level.

It is also an object of the present invention to provide a USB ribbon microphone wherein the transformer has a turn ratio of approximately 1:20 to 1:75.

It is another object of the present invention to provide a USB ribbon microphone wherein the amplification circuitry is a differential in—single out discrete low noise amplifier with variable gain stage.

It is a further object of the present invention to provide a USB ribbon microphone wherein the amplification circuitry has a high input impedance and a low output impedance enabling it to drive the A/D converter.

It is also an object of the present invention to provide a USB ribbon microphone wherein the amplification circuitry includes a differential input—single ended output stage followed by a variable gain stage, the differential input—single ended output stage multiplying voltage difference between inputs by a constant factor.

It is another object of the present invention to provide a USB ribbon microphone wherein the variable gain stage includes a common emitter with emitter degeneration amplifier.

It is a further object of the present invention to provide a USB ribbon microphone wherein the amplification circuitry further includes a unity gain amplifier stage following the variable gain stage.

It is also an object of the present invention to provide a USB ribbon microphone wherein the USB output includes a connector.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a front plan view of the present ribbon microphone.

FIG. 2 is a schematic of the circuitry employed in accordance with the present ribbon microphone.

### DESCRIPTION OF THE PREFERRED EMBODIMENT

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

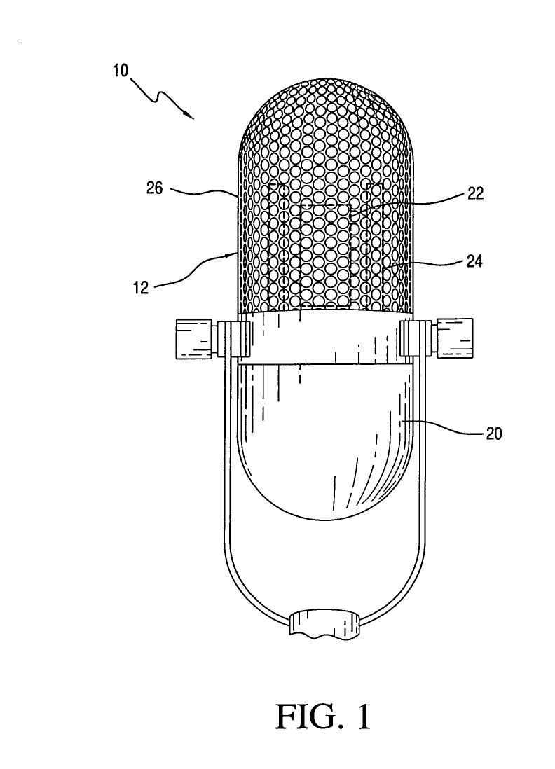

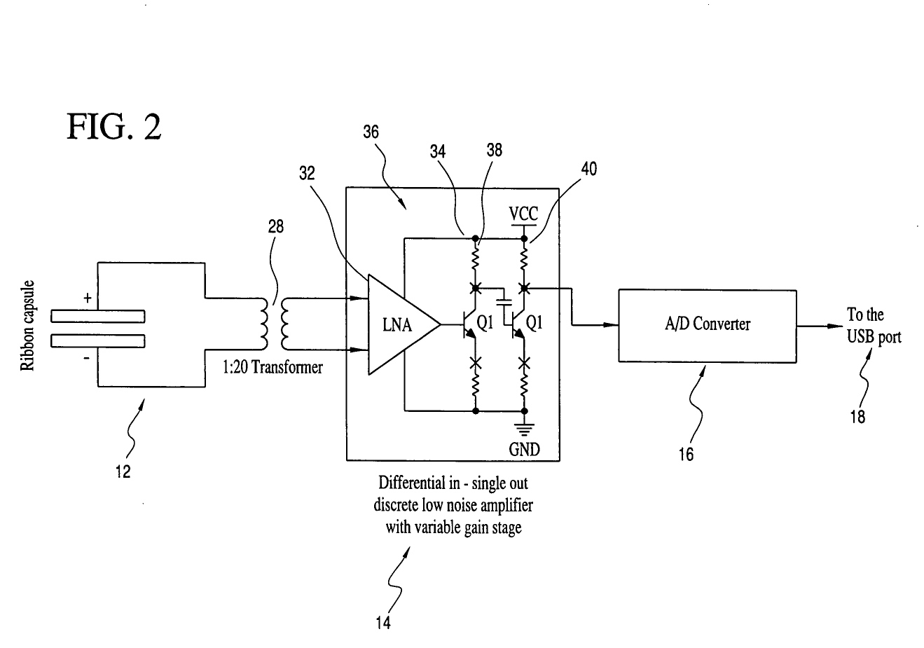

Referring to FIGS. 1 and 2, a USB ribbon microphone 10 is disclosed. The USB ribbon microphone 10 achieves classic ribbon sound utilizing USB technology and thereby allowing connection of the microphone 10 to audio equipment employing USB inputs, for example, various computers. The USB ribbon microphone 10 generally includes a ribbon diaphragm assembly 12, amplification circuitry 14, A/D converter 16 and a USB output port 18. All of the components are maintained within a housing member 20.

The ribbon diaphragm assembly 12 is electrical connected to the amplification circuitry 14 allowing for the analog to digital conversion of signals generated by the ribbon diaphragm assembly 12 as required for the utilization of the USB output port 18. The circuitry of the present USB ribbon microphone 10 produces outputs with low noise and high dynamic range that are functional with the USB output port 18.

As is appreciated, the ribbon diaphragm assembly 12 of the USB ribbon microphone 10 is composed of a thin aluminum ribbon diaphragm 22 placed between the poles of the magnet 24 to generate small AC voltages by electromagnetic induction, and thereby result in electrical signals. The ribbon diaphragm 12 is held within a housing 20 composed of an all metal body with a double shielded metal grill 26 preventing the generation of noise and hum from the high gain circuitry.

The magnet 24 is disposed on both sides of the ribbon diaphragm 22 to sandwich the same. As such, a magnetic field is formed between the positive and negative poles of the magnet 24 and the ribbon diaphragm 22 is positioned within the magnetic field. The ribbon diaphragm 22 is held with an appropriate tension and disposed within the magnetic field while both longitudinal ends are held down. In response to a sound wave coming from an individual or instrument or object in the vicinity of the microphone, the ribbon diaphragm 22 vibrates within the magnetic field generated by the magnet 24 and current corresponding to the sound wave flows through the ribbon diaphragm 22 converting the sound wave into an electrical signal.

In order to digitally process the analog audio signal generated by the ribbon diaphragm 22, the noise level of that audio signal needs to be within an acceptable range for digital USB applications before it can be processed through the A/D converter 16 and ultimately transmitted to the USB output port 18 of the present USB ribbon microphone 10. A signal noise level of 85-92 dB is needed for use in conjunction with USB circuitry where 92 dB is considered to be acceptable performance for a USB product. Since ribbon diaphragm assembly 12 can only generate voltages with very low signal amplitudes, an attempt to increase the gain of the signal using conventional methods (OPAMPS) almost always results in a signal with higher noise level making a ribbon diaphragm microphone unacceptable for digital USB microphone applications.

In accordance with the present invention, the audio signals generated by the poles of the magnet 24 are fed through a 1:20 transformer 28 and then into amplification circuitry 14 designed to minimize noise while increasing the signal level. In particular, the amplification circuitry 14 is a differential in—single out discrete low noise amplifier with variable gain stage.

The transformer 28 includes a turn ratio sufficient to get the signal from the ribbon diaphragm assembly 12 to a sufficiently higher level so that it can be sensed by the amplification circuitry 14. If the turn ratio of the transformer 28 is too high a great deal of hum will be picked-up from the ribbon diaphragm assembly 12 and the ribbon diaphragm assembly would require extensive shielding. In accordance with a preferred embodiment, the transformer 28 turn ratio is approximately 1:20 to approximately 1:75. The input of the A/D converter in a typical USB chip is 20 kOhm. Because it is a transistor based input, the input impedance it sees should be below 2000 Ohms which would make the ratio of the 1:20 the best compromise of gain and impedance. Using higher ratios would provide more gain but would cause too much hum and outside noise interference which would ultimately be difficult to filter out.

This audio low noise amplification circuitry 14 employed in accordance with the present invention has a high input impedance so that it does not load down the transformer output, and the final output stage of the amplification circuitry 14 has a low output impedance enabling it to drive the A/D converter 16. The differential discrete low noise amplification circuitry 14 employed in accordance with the present invention adds minimum noise to the signal while amplifying the signal to the required audio signal audible output voltage levels. Thus, the noise level in this signal after amplification is now in the acceptable range because of the improved signal to noise ratio (SNR) and the signal quality is good enough to be processed digitally through an A/D converter 16 for USB audio interfacing.

As mentioned above, the present amplification circuitry 14 includes a differential input—single ended output stage 32 followed by a variable gain stage 34. The differential input—single ended output stage 32 multiplies the voltage difference between the inputs by a constant factor, that is, the differential gain. The variable gain stage 34 uses a common emitter 36 with emitter degeneration amplifier 38 followed by a unity gain amplifier stage 40 (for phase adjustment). The selection of discrete semiconductors in the first stage is dependent on the low noise design considerations.

The signal resulting from the amplification circuitry is applied to an analog to digital converter 16 which feeds the digital signal to the USB output port 18. The USB output 18 includes a connector 42 coming directly out of the microphone housing 20 and is adapted for direct connection to a computer utilizing a standard USB input.

While the preferred embodiments have been shown and described, it will be understood that there is no intent to limit the invention by such disclosure, but rather, is intended to cover all modifications and alternate constructions falling within the spirit and scope of the invention.

1. A USB ribbon microphone, comprising:
a ribbon diaphragm assembly;
an amplification circuitry connected to the ribbon diaphragm assembly;
an A/D converter connected to the amplification circuitry; and
a USB output port connected to the A/D converter for selective connection with a USB input.

2. The USB ribbon microphone according to claim 1, wherein the ribbon diaphragm assembly is composed of a thin ribbon diaphragm placed between the poles of a magnet to generate small AC voltages by electromagnetic induction.

3. The USB ribbon microphone according to claim 1, wherein the amplification circuitry produces a signal noise level of 85-92 dB.

4. The USB ribbon microphone according to claim 1, further including a transformer between the ribbon diaphragm assembly and the amplification circuitry to minimize noise while increasing signal level.

5. The USB ribbon microphone according to claim 4, wherein the transformer has a turn ratio of approximately 1:20 to 1:75.

6. The USB ribbon microphone according to claim 1, wherein the amplification circuitry is a differential in—single out discrete low noise amplifier with variable gain stage.

7. The USB ribbon microphone according to claim 1, wherein the amplification circuitry has a high input impedance and a low output impedance enabling it to drive the A/D converter.

8. The USB ribbon microphone according to claim 1, wherein the amplification circuitry includes a differential input—single ended output stage followed by a variable gain stage, the differential input—single ended output stage multiplying voltage difference between inputs by a constant factor.

9. The USB ribbon microphone according to claim 8, wherein the variable gain stage includes a common emitter with emitter degeneration amplifier.

10. The USB ribbon microphone according to claim 9, wherein the amplification circuitry further includes a unity gain amplifier stage following the variable gain stage.

11. The USB ribbon microphone according to claim 1, wherein the USB output includes a connector.
